(19) United States
(12) Patent Application Publication
(10) Pub. No.: US 2006/0214887 A1
(43) Pub. Date: Sep. 28, 2006

(54) Image display method and image display apparatus

(76) Inventors: Katsuhiro Ishida, Yokohama (JP); Takashi Shiizaki, Yokohama (JP); Akira Yamamoto, Tokyo (JP); Shigeharu Asao, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/387,795

(22) Filed: Mar. 24, 2006

(30) Foreign Application Priority Data
Mar. 25, 2005 (JP) 2005-89650

(51) Int. Cl. G09G 3/28

(52) U.S. Cl. 345/63

(57) ABSTRACT

Conventionally, in an image display apparatus for gray-scale representation with two fields by a multiple gray-scaling scheme in which selective On-states in an odd field and an even field are made to differ, there has been a problem of deterioration in image quality due to occurrence of motion noise and flicker, for example. An image display method, in which a picture of one frame is configured by a plurality of sub-fields with different light-emitting display luminance levels, different selective On-states are capable of making to differ in accordance with display date inputted to an odd field and an even field, and a dither pattern for adding an arbitrary amount of data is capable of being inserted in accordance with the inputted display data, comprises the step of, for sorting the selective On-states in the odd and even fields and sorting the dither pattern, making at least one of a horizontal direction and a vertical direction to differ.

### CROSS-REFERENCE TO RELATED APPLICATION

The present application claims priority from Japanese patent application No. JP 2005-089650 filed on Mar. 25, 2005, the content of which is hereby incorporated by reference into this application.

### BACKGROUND OF THE INVENTION

The present invention relates to an image display method and an image display apparatus and, more particularly, to an image display method and an image display apparatus for gray-scale representation with two fields through a multiple gray-scaling scheme in which selective On-states in an even field and an odd field is made to differ.

In recent years, AC plasma display apparatuses for surface discharge have been commercially available as flat-type image display apparatuses, and have been widely used as flat-type wall-mounted televisions, display apparatuses for personal computers, workstations, and others, or apparatuses for displaying advertisements, information, and others. For example, a recent three-electrode surface-discharge-type plasma display apparatus has been suggested in which one frame is configured by an odd field and an even field and selective On-states in the odd field and the even field are made to differ for gray-scale representation.

However, for example, such a display apparatus for gray-scale representation with two fields, in which the selective On-states in the odd field and the even fields are made to differ through a multiple gray-scaling scheme, has a problem of deterioration in image quality. Therefore, provision of a plasma display apparatus in which deterioration in image quality due to occurrence of motion noise or flicker is suppressed has been demanded. Note that the present invention is not restricted to the plasma display apparatus, and can be widely applied to an image display apparatus for gray-scale representation with two fields through a multiple gray-scaling scheme in which selective On-states in an even field and an odd field are made to differ.

Conventionally, plasma display apparatuses for surface discharge have been commercially available as flat-type image display apparatuses, in which all pixels on a screen are simultaneously turned on in accordance with display data. The plasma display apparatus for surface discharge has a structure in which a pair of electrodes is formed on an inner surface of a front glass substrate and an inert gas is enclosed within the substrate. When a voltage is applied between these electrodes, surface discharges occur on surfaces of a dielectric layer and a protective layer formed on an electrode surface, whereby ultraviolet radiation occurs. On an inner surface of a rear glass substrate, phosphor materials of three primary colors, red (R), green (G), and blue (B), are coated. By making these phosphor materials excited and emitted by the ultraviolet radiation, color display is achieved.

FIG. 1 is a view schematically depicting a plasma display panel in a plasma display apparatus as one example of an image display apparatus, and shows a three-electrode surface-discharge AC plasma display panel.

In FIG. 1, the reference numeral “10” denotes a plasma display panel (PDP), “11” a front-side substrate (front substrate), “12” a transparent electrode for X electrode, “13” a bus electrode for X electrode, “14” a transparent electrode for Y electrode, “15” a bus electrode for Y electrode, “16” a rear-side substrate (rear substrate), “17” an address electrode, “18” a barrier rib, and “19R”, “19G”, and “19B” phosphor layers. Note that the actual PDP 10 is provided with a dielectric layer and a protective layer on the X electrode and Y electrode, respectively, and the dielectric layer is provided on the address electrode. Furthermore, a space between the front-side substrate 11 provided with the X electrodes (12 and 13) and the Y electrodes (14 and 15) and the rear-side substrate 16 provided with the address electrode 17 is filled with a discharge gas such as a mixed gas of neon and xenon. A discharge space of a crossing portion between the X and Y electrodes and the address electrode forms one discharge cell.

Note that discharge cells for R, G, and B are hereinafter referred to as sub-pixels and a dot configured by three discharge cells for R, G, and B is referred to as a pixel.

FIG. 2 is a block diagram schematically depicting a plasma display apparatus as one example of an image display apparatus and shows schematically one example of a plasma display apparatus 100 using the PDP 10 shown in FIG. 1.

As shown in FIG. 2, the plasma display apparatus 100 includes: the PDP 10; an X-side driver 32, a Y-side driver 33, and an address driver 34 for driving each discharge cell of the PDP 10; and a control circuit 31 for controlling each of these drivers. In the control circuit 31, field data (picture signal) Df, which is multilevel image data indicative of luminance levels of three colors, R, G, and B, and various synchronizing signals (a clock signal CLK, a horizontal synchronizing signal Hsync, and a vertical synchronizing signal Vsync) are inputted from an external device such as a TV tuner or a computer. Further, the control circuit 31 outputs control signals suitable for the respective drivers 32 to 34 from the field data Df and various synchronizing signals to carry out predetermined image display.

The Y-side driver 33 controls the Y electrode, and includes a scan driver (scan driver LSI) 331 and a common driver 332. The X-side driver 32 controls the X electrodes, and includes a common driver 320.

Meanwhile, conventionally, a display apparatus and a gray-scale display processing method have been suggested (for example, see Patent Document 1: Japanese Patent Laid-Open Publication No. 2002-366085) in which when PDP gray-scale display is performed based on γ-inversely-corrected display data, in order to suppress a decrease in maximum luminance and reduce a false contour of moving pictures, one field period is divided into eight sub-fields whose light-emitting times are weighted at a ratio of 0.5, 1.5, 4, 8, 16, 32, 64, and 128, and light-emitting patterns are switched between an odd field and an even field so that a level value of 10-bit data obtained by converting 8-bit data by a γ inverse correcting unit is an average value of a sum of light-emitting periods of a light-emitting pattern A and a sum of light-emitting periods of a light-emitting pattern B.

Also, conventionally, a gray-scale display processing apparatus and a processing method for plasma display panel have been suggested (for example, see Patent Document 2: Japanese Patent Laid-Open Publication No. 2002-268604) in which, in order to increase a display gray scale without increasing subfields to reduce a false contour of moving pictures and to ensure display with an excellent S/N ratio, 10-bit data obtained by converting 8-bit data by a γ inverse correcting unit is divided into upper 8-bit data and lower 2-bit data; of four pixels A, B, C, and D across a line of a PDP, an average value of the lower two bits for pixels C and D is calculated; and, based on the calculation result and each of even and odd fields, it is determined whether a display minimum level value is to be added to each piece of 8-bit data for the pixels A, B, C, and D.

### SUMMARY OF THE INVENTION

FIGS. 3A and 3B are views for describing one example of a conventional multiple gray-scaling scheme, and shows one example of an On-state in a scheme in which one frame is configured by two fields, that is, an odd field and an even field, and gray-scale representation is performed by differing selective On-states in the odd field and the even field.

As shown in FIG. 3A, a luminance ratio (weight) for sub-fields SF1 to SF3 in each of the odd field and the even field is “SF1:SF2:SF3=1:3:9”. As shown in FIG. 3B, for example, in order to represent a gray-scale level of 1, only the sub-field SF1 with a luminance ratio of 1 is turned on in the odd field (A) and all of the sub-fields SF1 to SF3 are turned off in the even field (B). In order to represent a gray-scale level of 2, only the sub-field SF1 with a luminance ratio of 1 is turned on in both of the odd field and the even field. In order to represent a gray-scale level of 3, only the sub-field SF2 with a luminance ratio of 3 is turned on in the odd field (A) and all of the sub-fields SF1 to SF3 are turned off in the even field (B). As such, in the odd field and the even field, the sub-fields SF1 to SF3 are selectively turned on, whereby the gray-scale levels of 0 to 26 are represented.

FIG. 4 is a view depicting one example in which, in the multiple gray-scaling scheme shown in FIG. 3, ON-states of the odd field (A mode) and the even field (B) are sorted in units of pixel in a staggered manner.

As evident from FIG. 4, the pixels sorted in a staggered manner are alternately driven in the odd fields and even fields.

FIG. 5 is a view depicting how a picture synthesized by the odd and even fields is viewed when a gray-scale level of 1 is turned on, in the multiple gray-scaling scheme shown in FIG. 3.

As described above, when the gray-scale representation is performed with two fields in which the selective On-states in the odd and even fields are made to differ, as shown in FIG. 3, for example, for representation of a gray-scale level of 1, SF1 is turned on in the odd field, whilst SF1 is turned off in the even field. At this time, as shown in FIG. 4, there has been considered the case where the odd field (A) and the even field (B) are sorted in a staggered manner in the units of pixel in a horizontal direction and in the units of line in a vertical direction. Then, when a solid picture (display image) with a gray-scale level of 1 is scrolled by one pixel per field in the horizontal direction (right direction), the picture synthesized by the odd and even fields is viewed as shown in FIG. 5.

That is, as shown on a right side of FIG. 5, when a solid picture with a gray-scale level of 1 is scrolled by one pixel per field in a right direction, the picture becomes a dot-staggered picture with a luminance level twice as much as that of a still picture (see a lower-right side of FIG. 5). Accordingly, in general cases, as shown on a left side of FIG. 5, when the odd field (A) and the even field (B) are sorted in a staggered manner in units of pixel in a horizontal direction and in units of line in a vertical direction and when the picture is scrolled by one pixel per field in the right direction, the picture synthesized by the odd field and the even field is such that brightness in an arrowed direction is synthesized and A+A, B+B, A+A, . . . is viewed between adjacent dots (pixels) (see a lower-left side of FIG. 5).

Also, when a user views a picture displayed on a display panel of the image display apparatus, even if the user moves his or her line of sight, the picture is viewed in a manner identical to that when the picture is scrolled. Therefore, for example, if the picture is a solid white picture with a gray-scale level of 1, even when the picture is scrolled or the line of sight is moved, the picture merely becomes a staggered picture and therefore its deterioration in image quality is not so conspicuous. However, if the outputted picture is slightly changed due to error diffusion or picture noise, the deterioration in image quality may be significantly conspicuous.

FIGS. 6A and 6B are views each depicting how a picture synthesized by odd and even fields is viewed when pictures of two On-state examples are inputted, in the multiple gray-scaling scheme shown in FIG. 3. FIGS. 6A and 6B each show the case where in displaying a white solid picture with a gray-scale level of 1, one pixel (dot) has a gray-scale level of 0 (zero) in each of the odd and even fields.

A first On-state example shown in FIG. 6A is viewed so that a picture with “a gray-scale lever of 2” is lost at a dot P0. On the other hand, a second On-state example shown in FIG. 6B is viewed so that a picture with “a gray-scale level of 2” is staggered at all relevant dots. That is, for example, when the odd and even fields are provided with display data in which only one of 16 dots (pixels) of 4×4 becomes “0” (zero), image quality will deteriorate when a predetermined relation with picture scrolling is held (for example, a matching relation is held).

In performing the actual picture display, the above-described situation occurs simultaneously on the entire screen. If the first On-state example and the second On-state example randomly occur, for example, a portion of a picture with “a gray-scale level of 0 (zero)” occurs randomly to cause noise, so-called motion noise (noise when a picture is moved), thereby making the picture fuzzy. Moreover, at the time of display, if the gray-scale levels for each color are made to differ, the strong motion noise occurs and image quality further deteriorates.

FIG. 7 is a view depicting one example of a staggered dither pattern for use in a conventional multiple gray-scaling scheme.

As means for suppressing the above-described motion noise, there is conventionally known a scheme in which the staggered dither pattern shown in FIG. 7 is added to display data and a carry portion of a light-emitting place is fixed. By adding such a dither pattern, a portion with “0” (zero) in the first On-state example shown in FIG. 6A becomes “+C”, so that approximately all portions become in a state of the second On-state example as shown in FIG. 6B and the motion noise is suppressed.

FIG. 8 is a view for explaining a problem caused in the dither pattern shown in FIG. 7, and shows the case of A=0, B=0, and C=1.

Meanwhile, when the staggered dither pattern shown in FIG. 7 is used, a new problem arises. That is, when a solid pattern of a picture with approximately a half of a gray-scale level of 1 is inputted due to error diffusion, if the dither pattern as shown in FIG. 7 is added to the display data, the pattern becomes the same as that when a staggered pattern with “a gray-scale level of 1” (C=1) shown on a left side of FIG. 8 is added. At this time, as shown on a right side of FIG. 8, the odd field (A mode) has the staggered On-states and the even field (B mode) has the OFF-states. Therefore, for example, a flicker of 30 Hz (in the case where picture display is performed with 60 fields for one minute) occurs, which results in deterioration in image quality.

That is, for example, in an image display method for a plasma display panel, when gray-scale representation is performed with two fields by a multiple gray-scaling scheme in which the selective On-states in the odd field and the even field are made to differ, motion noise or the like occurs and image quality deteriorates by a difference caused by a slight change in a picture slightly outputted due to error diffusion or picture noise. Moreover, if a dither pattern for suppressing such motion noise or the like is inserted, a new problem about the flicker arises, thereby also resulting in deterioration in image quality.

In view of the problems that the above-described conventional image display method has, an object of the present invention is to provide an image display apparatus and an image display method capable of suppressing deterioration in image quality due to motion noise or flicker, in an image display technology for carrying out gray-scale representation with two fields by a multiple gray-scaling scheme in which selective ON-states in an odd field and an even field are made to differ.

According to a first aspect of the present invention, an image display method, in which a picture of one frame is configured by a plurality of sub-fields with different light-emitting display luminance levels, different selective On-states are capable of making to differ in accordance with display date inputted to an odd field and an even field, and a dither pattern for adding an arbitrary amount of data is capable of being inserted in accordance with the inputted display data, comprises the step of, for sorting the selective On-states in the odd and even fields and sorting the dither pattern, making at least one of a horizontal direction and a vertical direction differ.

According to a second aspect of the present invention, an image display apparatus comprising: a display panel; a driver for driving each of sub-pixels of the display panel; and a control circuit for controlling the driver, wherein to the image display apparatus, there is applied the image display method, in which a picture of one frame is configured by a plurality of sub-fields with different light-emitting display luminance levels, different selective On-states are capable of making to differ in accordance with display date inputted to an odd field and an even field, and a dither pattern for adding an arbitrary amount of data is capable of being inserted in accordance with the inputted display data, the method comprising the step of, for sorting the selective On-states in the odd and even fields and sorting the dither pattern, making at least one of a horizontal direction and a vertical direction differ.

According to the present invention, it is possible to provide the image display apparatus and the image display method capable of suppressing the deterioration in the image quality due to the motion noise or flicker, in an image display technology for performing the gray-scale representation with two fields by the multiple gray-scaling scheme in which the selective On-states in the odd field and the even field are made to differ.

### BRIEF DESCRIPTION OF THE DRAWINGS

FIG. 1 is a view schematically depicting a plasma display panel in a plasma display apparatus as one example of an image display apparatus;

FIG. 2 is a block diagram generally depicting a plasma display apparatus as one example of an image display apparatus;

FIGS. 3A and 3B are views for describing one example of a conventional multiple gray-scaling scheme;

FIG. 4 is a view depicting one example, in which On-states in an odd field and an even field are sorted in a staggered manner in units of pixel, in the multiple gray-scaling scheme shown in FIG. 3;

FIG. 5 is a view depicting how a picture synthesized in the odd and even fields is viewed at a time of turning on a gray-scale level of 1 in the multiple gray-scaling scheme shown in FIG. 3;

FIG. 6A is a view depicting how a picture synthesized in the odd and even fields is viewed when pictures of two On-state examples are inputted, in the multiple gray-scaling scheme shown in FIG. 3;

FIG. 6B is a view depicting how a picture synthesized in the odd and even fields is viewed when pictures of two On-state examples are inputted, in the multiple gray-scaling scheme shown in FIG. 3;

FIG. 7 is a view depicting one example of a staggered dither pattern for use in the conventional multiple gray-scaling scheme;

FIG. 8 is a view for explaining a problem caused in the dither pattern shown in FIG. 7;

FIG. 9 is a view depicting the case where, as one example of an image display method according to the present invention, the odd and even fields in a vertical direction are sorted in units of two lines and a dither pattern is sorted in units of line;

FIG. 10 is a view depicting one On-state example in the image display method shown in FIG. 9;

FIG. 11 is a view depicting how a picture synthesized at a time of scrolling the On-state example shown in FIG. 10 in a horizontal direction at a speed of one pixel per field is viewed;

FIG. 12 is a view depicting the case where odd and even fields in a horizontal direction are sorted in units of sub-pixel, a dither pattern in the horizontal direction is in units of pixel, odd and even fields in a vertical direction are sorted in units of two lines, and a dither pattern in the vertical direction is in units of line;

FIG. 13 is a view depicting how a picture synthesized at the time of being scrolled in the horizontal direction at a speed of one pixel per field is viewed in the case where A=C=0.5 and B=0 with respect to the sorting scheme shown in FIG. 12;

FIG. 14 is a view depicting how a picture synthesized at the time of being scrolled in the vertical direction at a speed of two lines per field is viewed in the case where A=C=0.5 and B=0 with respect to the sorting scheme shown in FIG. 12;

FIG. 15 is a view depicting the case where odd and even fields in a horizontal direction are sorted in units of sub-pixel, a dither pattern in the horizontal direction is in units of pixel, they in a vertical direction are sorted in units of two lines, and further a dither distribution is shifted by one line in the vertical direction;

FIG. 16 is a view depicting how a picture synthesized at the time of being scrolled in the vertical direction at a speed of two lines per field is viewed in the case where A=C=0.5 and B=0 with respect to the sorting scheme shown in FIG. 15; and

FIG. 17 is a block diagram showing a main portion of the image displaying apparatus according to the present invention.

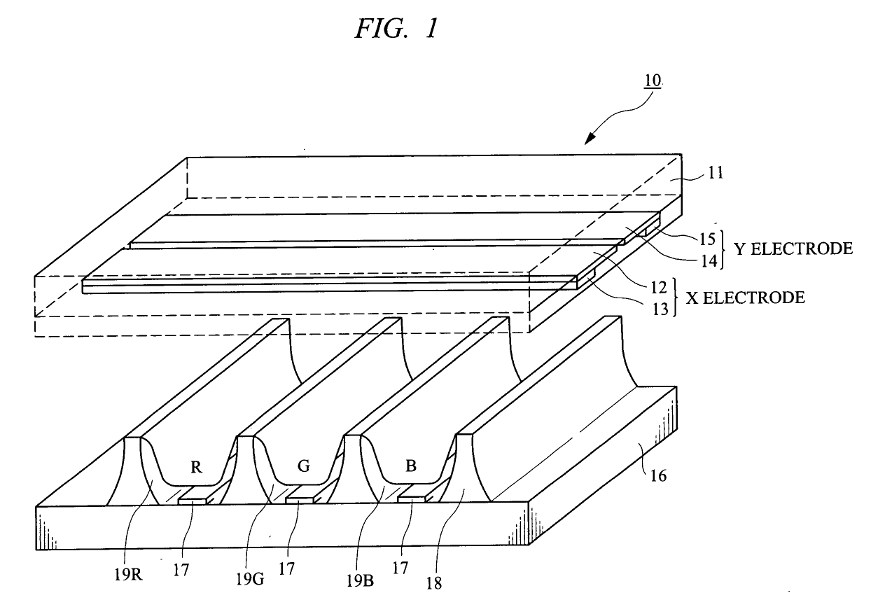

### DESCRIPTION OF THE PREFERRED EMBODIMENTS

In the present invention, in order to suppress side effects of flicker caused by inserting the above-described dither pattern in the conventional technology, a sorting scheme of selective On-states in odd and even fields and a sorting scheme of a dither pattern are performed in such a manner that patterns in at least one of a horizontal direction and a vertical direction are not the same. That is, if the patterns in at least one of the patterns in horizontal and vertical directions are not the same, it is possible to avoid a state in which the dither pattern is turned on and off in the odd field and the even field, thereby achieving picture display without deterioration in image quality due to motion noise, flicker, and the like.

With reference to the accompanying drawings, embodiments of an image display method and an image display apparatus according to the present invention will be described in detail below.

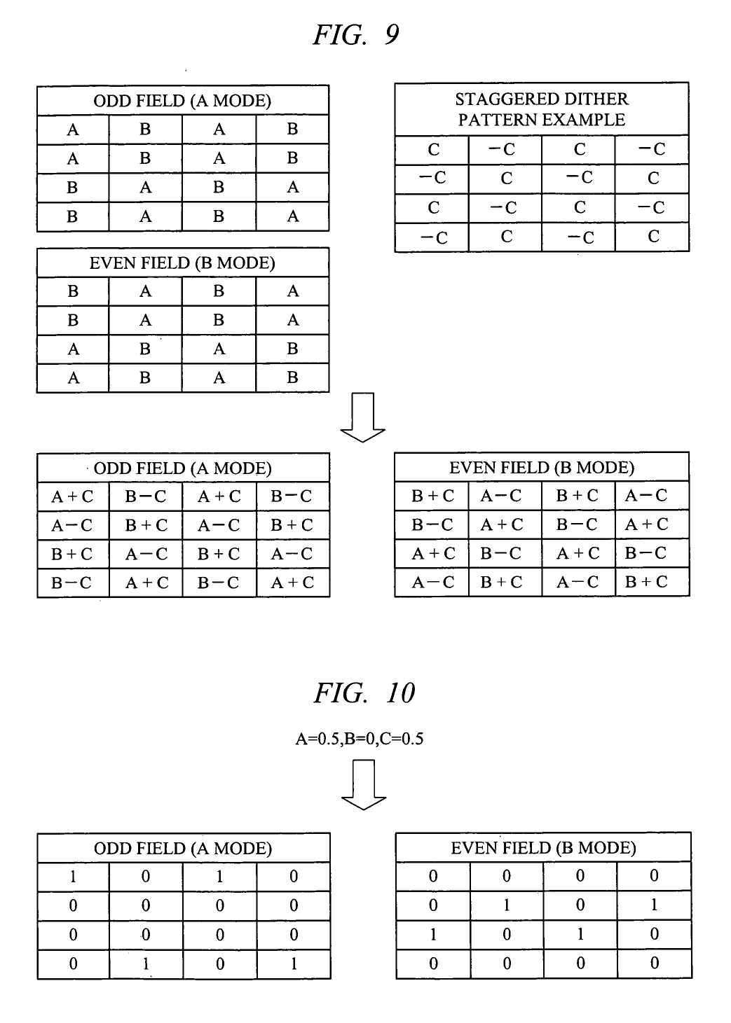

FIG. 9 is a view depicting, as one example of the image display method according to the present invention, the case where odd and even fields in a vertical direction are sorted in units of two lines and a dither pattern in the vertical direction is in units of line, and shows an example in which a sorting scheme of the odd and even fields and a sorting scheme of the dither pattern are performed in a such manner that these schemes are made to differ from each other only in the vertical direction.

In the present embodiment, pictures in the horizontal direction are fixed in units of pixel, but the odd and even fields in the vertical direction are sorted in units of two lines and the dither pattern is in units of line, which is set to be different from the former.

Furthermore, FIG. 9 depicts a total level when the dither is added (added or subtracted) with respect to sorting of odd and even fields at a still picture. Here, considering the example of FIG. 8 showing a model in which flicker occurs, the sorting of the odd and even fields of FIG. 9 is the same as that in such a manner that A=0.5, B=0, and C=0.5. Note that all gray-scale levels less than the gray-scale level of “1” become “0”.

FIG. 10 is a view depicting one On-state example in the image display method shown in FIG. 9, and shows the case where coefficients A=0.5, B=0, and C=0.5 are applied to the sorting of the odd and even fields of FIG. 9.

As described above, in the conventional technology shown in FIG. 8, On-states and OFF-states are repeated in the odd and even fields, whereby a flicker of 30 Hz is generated, for example. On the other hand, in the present embodiment shown in FIG. 10, both of the odd and even fields are turned on, so that flickers are suppressed.

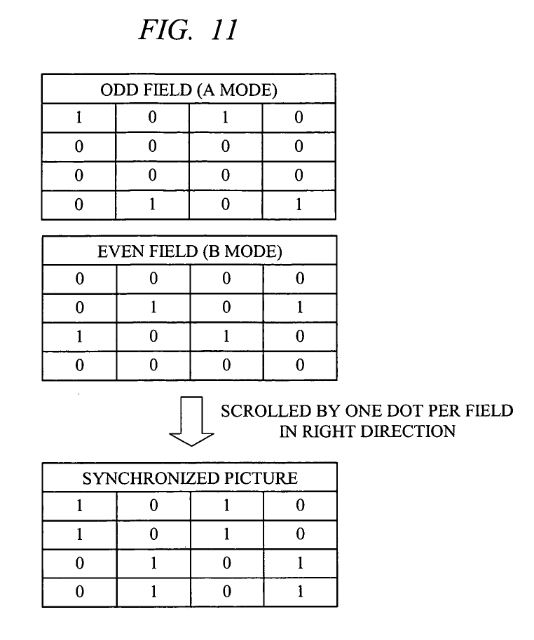

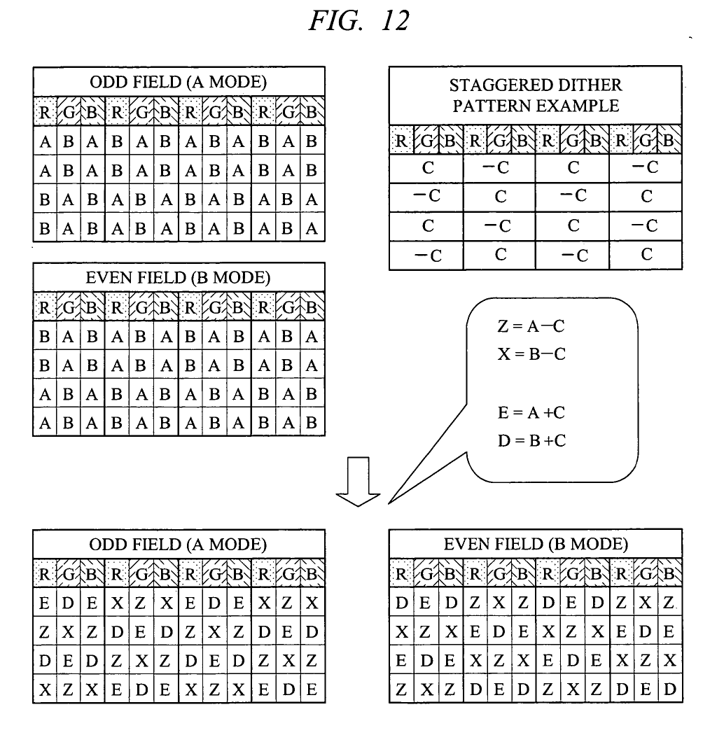

FIG. 11 is a view depicting how a picture synthesized at a time of scrolling the On-state example shown in FIG. 10 in a horizontal direction at a speed of one pixel per field is viewed, and a view depicting how a picture obtained by scrolling the On-state example of FIG. 10 in a manner shown in FIG. 5, that is, in a right direction by one pixel per field, is viewed.

As shown in FIG. 11, when the picture is scrolled in the right direction at the speed of one pixel per field, the synthesized picture is viewed as a staggered image in units of pixel in the horizontal direction and in units of two lines in the vertical direction.

Next, in FIG. 12, there is shown the case where, as a state in which the patterns in the horizontal direction are not the same, the odd and even fields are sorted in units of sub-pixel and the dither pattern is sorted in units of pixel and where, as a state in which the patterns in the vertical direction are similarly not the same, the odd and even fields are sorted in units of two lines and the dither pattern is sorted in units of line.

That is, FIG. 12 depicts an example in which the odd and even fields in a horizontal direction are sorted in units of sub-pixel, the dither pattern in the horizontal direction is in units of pixel, the odd and even fields in a vertical direction are sorted in units of two lines, and the dither pattern in the vertical direction is in units of line. Here, as described above, a sub-pixel represents a discharge cell for each of the colors R, G, and B, and a pixel represents a dot configured by three discharge cells for R, G, and B.

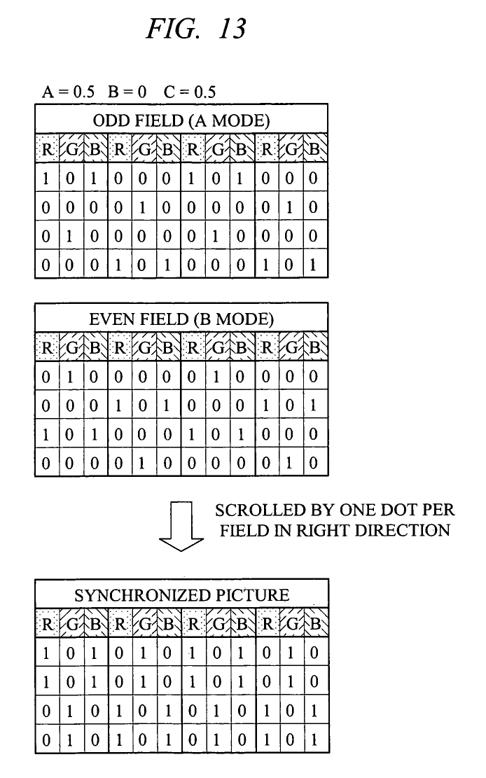

At this time, as considered in FIG. 11, FIG. 13 showing how a picture scrolled by one pixel per field in the right direction is viewed when A=0.5, B=0, and C=0.5.

That is, FIG. 13 depicts how a picture synthesized at the time of being scrolled in the right direction at a speed of one pixel per field is viewed in the case where A=C=0.5 and B=0 with respect to the sorting scheme shown in FIG. 12.

The synthesized picture shown in FIG. 13 is viewed as a staggered picture in units of sub-pixel in the horizontal direction and in units of two lines in the vertical direction. As compared with the example of FIG. 11 described above, when the picture is made more finely in the horizontal direction, further deterioration in image quality can be suppressed.

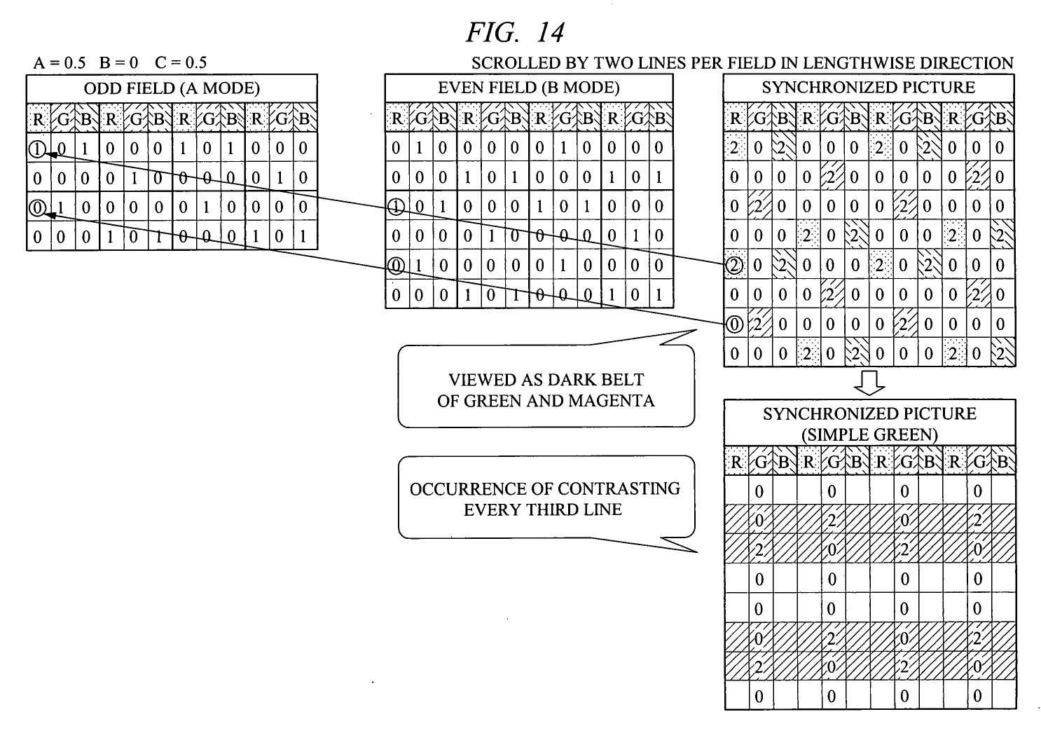

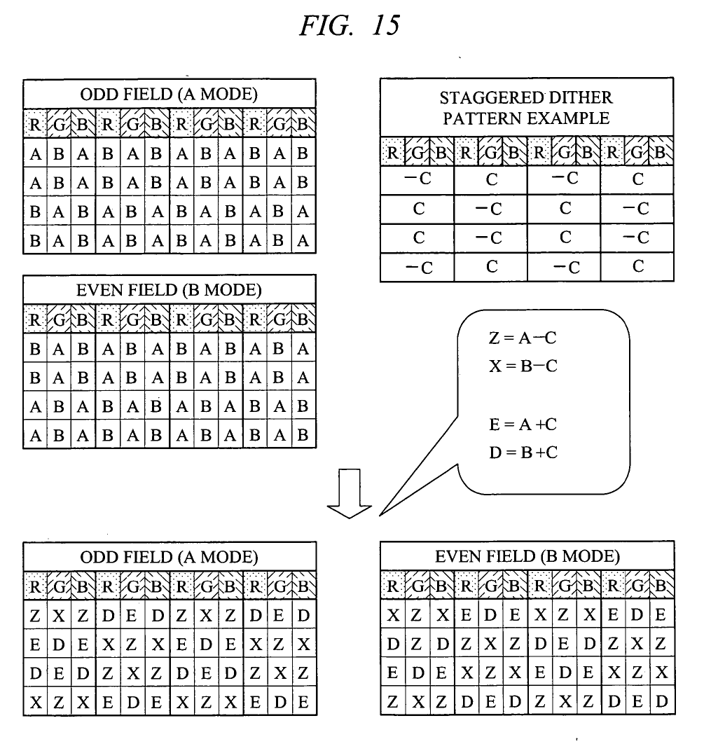

Next, FIG. 14 shows how the picture in the example of FIG. 13 is viewed at the time of being scrolled by two lines per field in the vertical direction.

That is, FIG. 14 depicts how a picture synthesized at the time of being scrolled in the vertical direction at a speed of two lines per field is viewed in the case where A=C=0.5 and B=0 with respect to the sorting scheme shown in FIG. 12.

As such, in being scrolled in the vertical direction, if white is at A=0.5, B=0, and C=0.5, magenta lines and green lines are viewed in units of two lines. Also, simple-green belts in units of two lines are conspicuous, thereby resulting in deterioration in image quality.

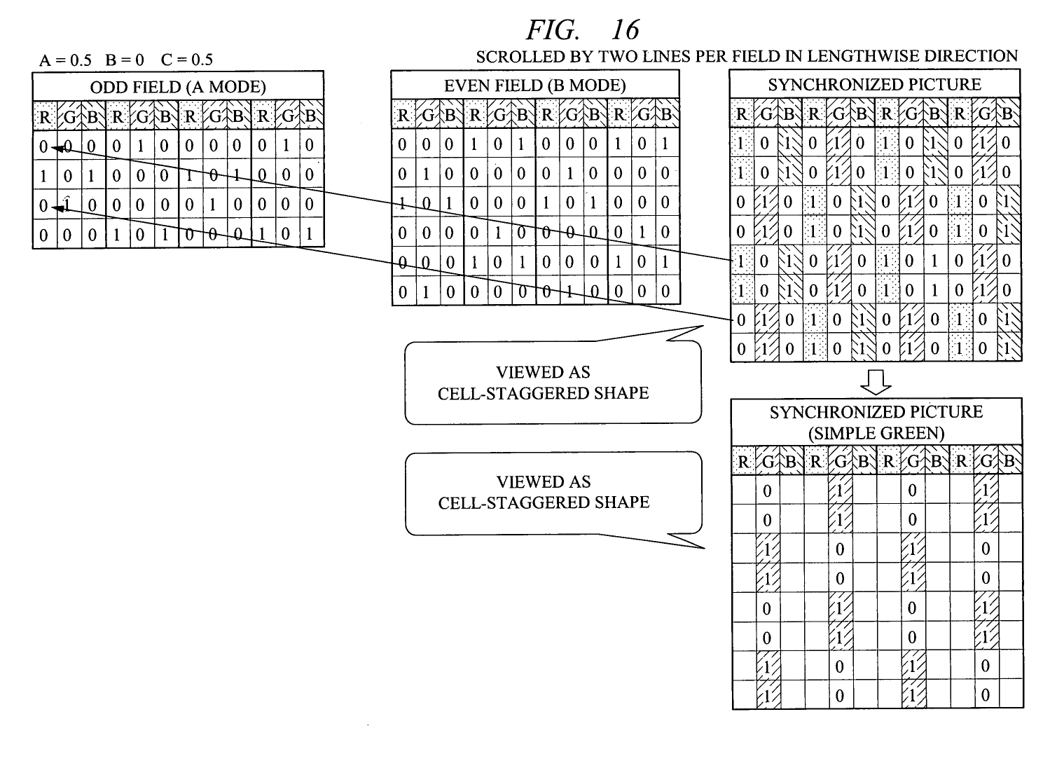

Therefore, FIG. 15 shows the case where: the odd and even fields in the horizontal direction are sorted in units of sub-pixel; the dither pattern in the horizontal direction is kept to be sorted in units of pixel; they in the vertical direction are sorted in units of two lines; and the dither pattern is shifted by one line in the vertical direction.

That is, FIG. 15 depicts an example in which: the odd and even fields in the horizontal direction are sorted in units of sub-pixel; the dither pattern in the horizontal direction is in units of pixel; they in the vertical direction are sorted in units of two lines; and further a dither pattern is shifted by one line with respect to the vertical direction.

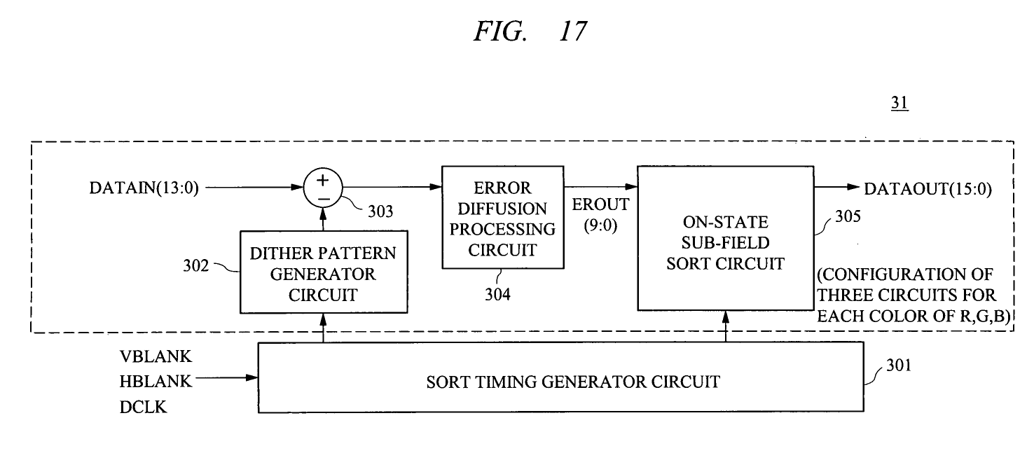

Next, FIG. 16 shows how the picture in FIG. 15 is viewed at the time of being scrolled by two lines per field in the vertical direction.

That is, FIG. 16 depicts how a picture synthesized at the time of being scrolled in the vertical direction at a speed of two lines per field is viewed when A=C=0.5 and B=0 with respect to the distribution scheme shown in FIG. 15.

As such, at the time of being scrolled in the vertical direction, in the case where white is at A=0.5, B=0, and C=0.5, a cell-staggered display in units of two lines is viewed in the vertical direction and, as for simple green, a dot-staggered display in units of two lines is viewed. Therefore, as compared with FIG. 14, the picture becomes finer without being made to feel uncomfortable.

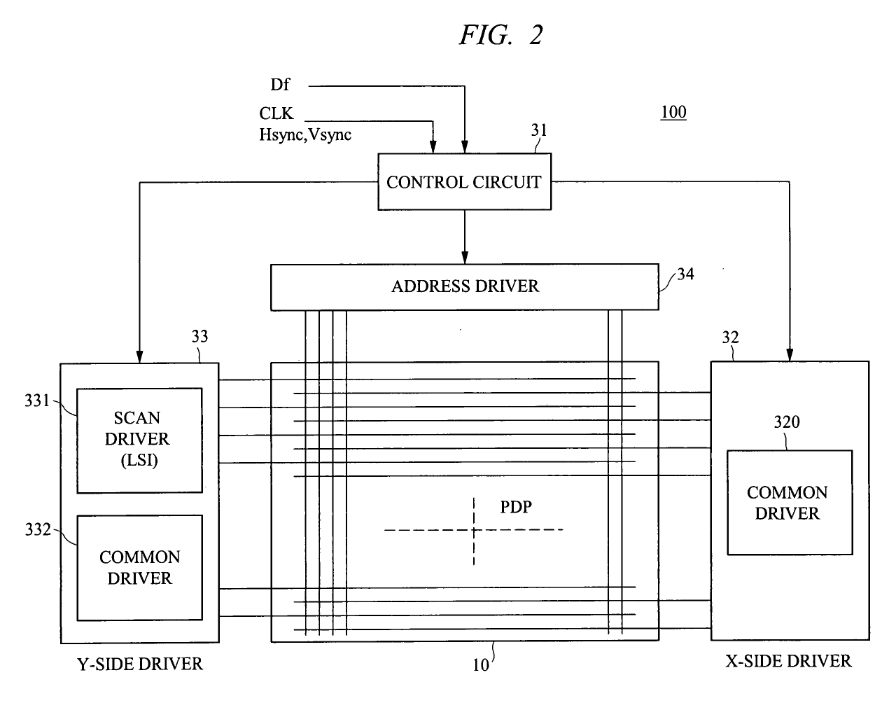

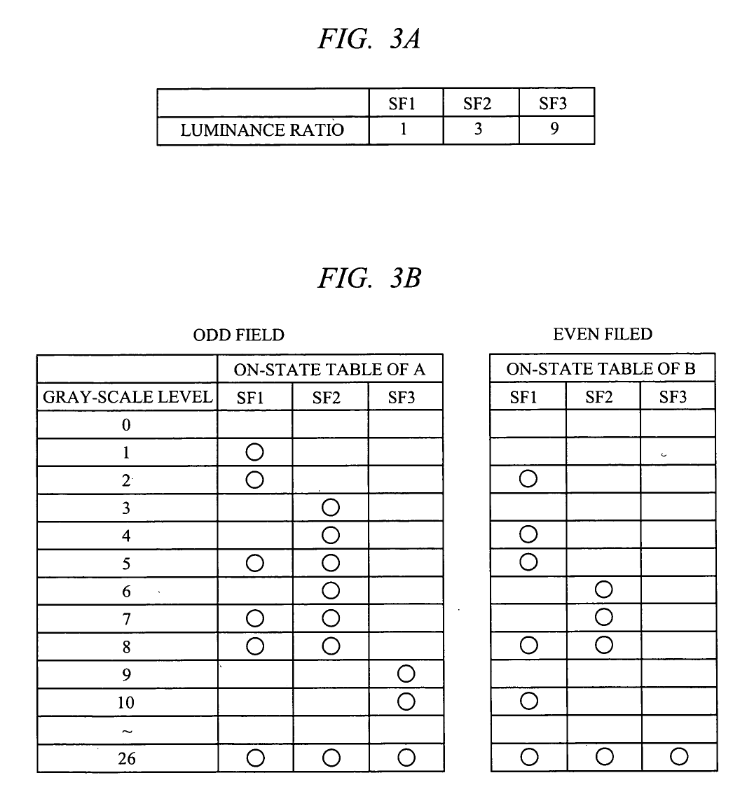

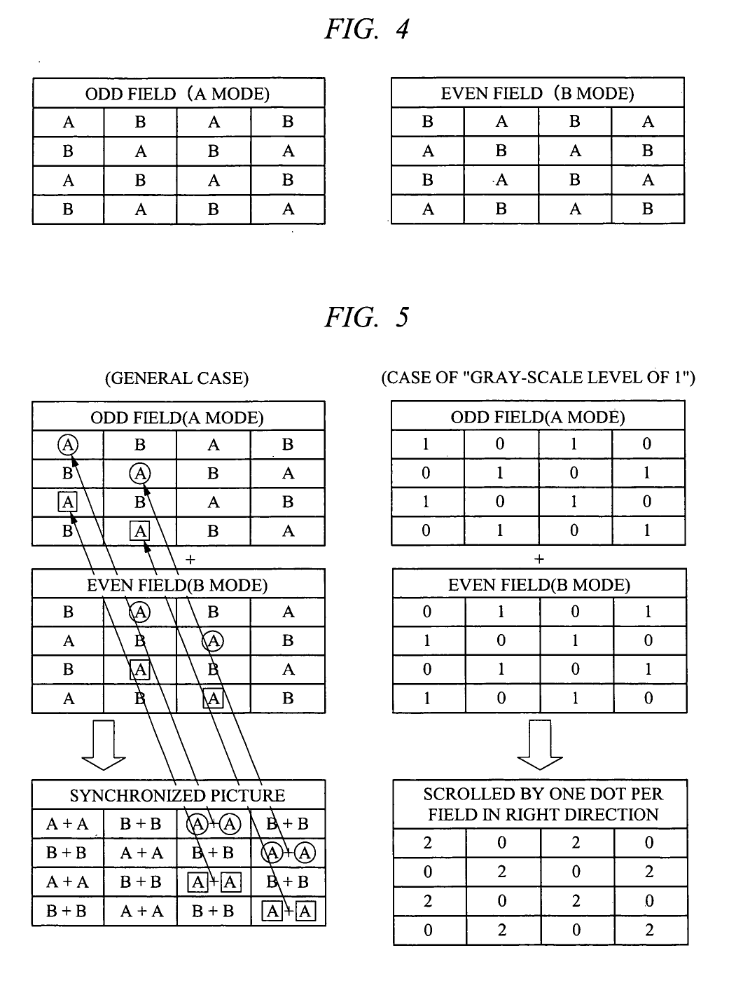

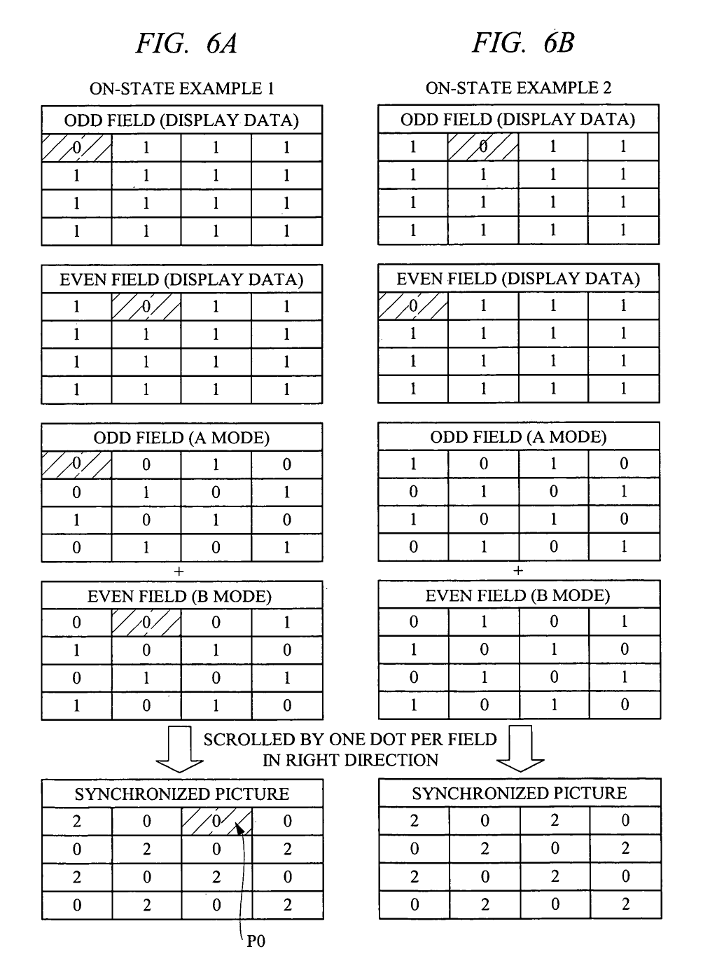

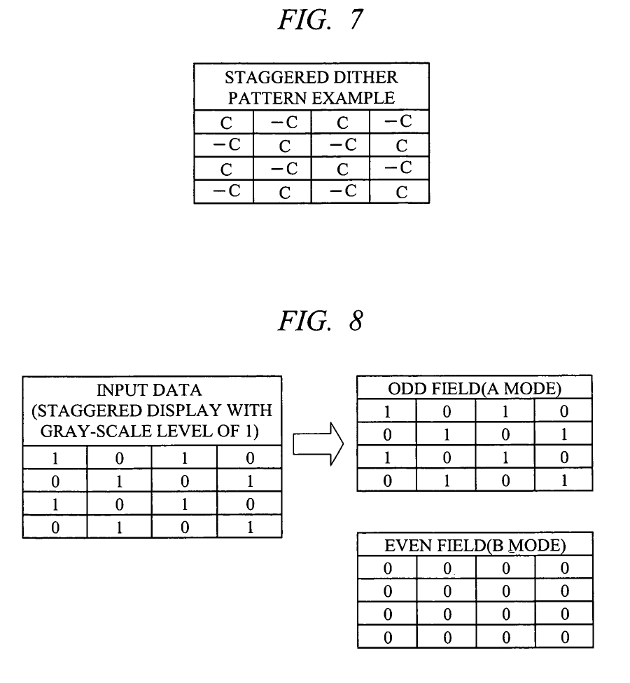

FIG. 17 is a block diagram showing a main portion of the image displaying apparatus according to the present invention and shows, more particularly, the main portion of the control circuit 31 in the above-described plasma display apparatus of FIG. 2. In FIG. 17, the reference numeral “301” denotes a sort timing generator circuit, “302” a dither pattern generator circuit, “303” an adder (adder/subtractor) circuit, and “305” an On-state sub-field sort circuit.

The sort timing generator circuit 301 generates sort timings for dots, lines, and frames. Upon receiving a vertical blanking signal (VBLANK), a horizontal blanking signal (HBLANK), and a data clock signal (DCLK), the sort timing generator circuit 301 generates a dither sort timing signal and timing signals for sorting the odd and even fields in synchronization with each other. The dither sort timing signal from the sort timing generator circuit 301 is then supplied to the dither pattern generator circuit 302, whilst the timing signals for sorting the odd and even fields are supplied to the On-state sub-field sort circuit 305.

The dither pattern generator circuit 302 generates a dither pattern in which “C” and “−C” are sorted in the above-described manner in accordance with the dither sort timing signal from the sort timing generator circuit 301, and then supplies the dither pattern to the adder circuit 303. The adder circuit 303 adds (adds/subtracts) the dither pattern from the dither pattern generator circuit 302 and a picture signal DATAIN (for example, a 14-bit signal) supplied from the outside together, and then supplies the result to an error diffusion processing circuit 304. An output from the error diffusion processing circuit 304 is cut off so that an On-state sub-field sort input becomes EROUT (for example, 10-bit signal) so as to correspond to an On stage, and is then supplied to the On-state sub-field sourt circuit 305.

The On-state sub-field sort circuit 305 receives an addition value of the dither pattern and the picture signal by the adder circuit 303, and then outputs: an EROUT (for example, 10-bit signal) so as to correspond to the On stage through the error diffusion processing circuit 304 with respect to an output based on the sort timing signals of the odd and even fields from the sort timing generator circuit 301; and a picture signal DATAOUT (for example, 16-bit signal) subjected to the above-described sort into “A” and “B”. Note that as described above, the dither sort timing signal inputted to the dither pattern generator circuit 302 and the timing signals for sorting the odd and even fields inputted to the On-state sub-field sort circuit 305 are synchronized with each other. Also, the picture signal DATAOUT is processed by another circuit in the control circuit 31, and then is displayed as a predetermined picture at a display panel via each driver.

Here, A=C=0.5 shown as the examples in FIGS. 10, 13, 14, and 16 means that a gray-scale level is defined as 1 (one) when SF1 is turned on. Therefore, if it is assumed that EROUT is a 10-bit signal and DATAIN is a 14-bit signal as shown in the circuitry configuration of FIG. 17, A=C=8 is held and when an input of the error diffusion processing circuit 304 is 16, EROUT becomes 1 (one) and SF1 becomes in an On-state.

As such, since the sorting of the dither and the sorting of the odd and even fields are made in synchronization with each other, both sorts in the vertical direction can be made in units of two lines, whereby one of these sorts is shifted by one line, for example.

As described in detail above, in the image display apparatus and the image display method according to the present invention, when the gray-scale representation is performed with two fields by the multiple gray-scaling scheme in which the selective On-states in the even and odd fields are made to differ, although the deterioration in the image quality due to the motion noise, flicker, and other factors occurs as side effects, an excellent picture in which the deterioration in the image quality is suppressed can be obtained by sorting differently the pictures in one or both of the horizontal direction and the vertical direction about the sorting scheme of the selective On-states in the odd and even fields and the sorting scheme of the dither pattern.

The present invention can be applied to three-electrode surface-discharge-type plasma display apparatuses that have been widely used as display apparatuses for personal computers, workstations, and others, flat-type wall-mounted televisions, or apparatuses for displaying advertisements, information, and others. Furthermore, the present invention can be widely applied to image display apparatuses for gray-scale representation with two fields by a multiple gray-scaling scheme in which selective On-states in even and odd fields are made to differ.

What is claimed is:

1. An image display method, in which a picture of one frame is configured by a plurality of sub-fields with different light-emitting display luminance levels, different selective On-states are capable of making to differ in accordance with display date inputted to an odd field and an even field, and a dither pattern for adding an arbitrary amount of data is capable of being inserted in accordance with the inputted display data, the method comprising the step of:
for sorting the selective On-states in the odd and even fields and sorting the dither pattern, making at least one of a horizontal direction and a vertical direction differ.

2. The image display method according to claim 1,
wherein sorting the selective On-states in the odd and even fields is made in units of pixel in a horizontal direction and in units of two lines in a vertical direction, and sorting the dither pattern is made in units of pixel in the horizontal direction and in units of line in the vertical direction.

3. The image display method according to claim 1,
wherein sorting the selective On-states in the odd and even fields is made in units of pixel in a horizontal direction and in units of two lines in a vertical direction, and sorting the dither pattern is made in units of pixel in the horizontal direction and in units of two lines in the vertical direction and is shifted by one line from sorting the selective On-states in the odd and even fields in the vertical direction.

4. The image display method according to claim 1,
wherein for sorting the selective On-states in the odd and even fields and sorting the dither pattern, both of the horizontal direction and the vertical direction are made to differ.

5. The image display method according to claim 4,
wherein sorting the selective On-states in the odd and even fields is made in units of sub-pixel in the horizontal direction and in units of two lines in the vertical direction, and sorting the dither pattern is made in units of pixel in the horizontal direction and in units of line in the vertical direction.

6. The image display method according to claim 5,
wherein sorting the selective On-states in the odd and even fields is made in units of pixel in the horizontal direction and in units of two lines in the vertical direction, and sorting the dither pattern is made in units of sub-pixel in the horizontal direction and in units of line in the vertical direction.

7. The image display method according to claim 5,
wherein sorting the selective On-states in the odd and even fields is made in units of sub-pixel in the horizontal direction and in units of line in the vertical direction, and sorting the dither pattern is made in units of pixel in the horizontal direction and in units of two lines in the vertical direction.

8. The image display method according to claim 5,
wherein sorting the selective On-states in the odd and even fields is made in units of pixel in the horizontal direction and in units of line in the vertical direction, and sorting the dither pattern is made in units of sub-pixel in the horizontal direction and in units of two lines in the vertical direction.

9. The image display method according to claim 4,
wherein sorting the selective On-states in the odd and even fields is made in units of sub-pixel in the horizontal direction and in units of two lines in the vertical direction, and sorting the dither pattern is made in units of pixel in the horizontal direction and in units of two lines in the vertical direction.

10. The image display method according to claim 9,
wherein sorting the selective On-states in the odd and even fields is made in units of pixel in the horizontal direction and in units of two lines in the vertical direction, and sorting the dither pattern is made in units of sub-pixel in the horizontal direction and in units of two lines in the vertical direction and is shifted by one line from sorting the selective On-states in the odd and even fields in the vertical direction.

11. The image display method according to claim 4,
wherein sorting the selective On-states in the odd and even fields is made in units of two sub-pixels in the horizontal direction and in units of two lines in the vertical direction, and sorting the dither pattern is made in units of two sub-pixels in the horizontal direction and shifted by one sub-pixel from sorting the selective On-states in the odd and even fields in the horizontal direction, and is made in units of line in the vertical direction.

12. The image display method according to claim 11,
wherein sorting the selective On-states in the odd and even fields is made in units of two sub-pixels in the horizontal direction and in units of two lines in the vertical direction, and sorting the dither pattern is made in units of two sub-pixels in the horizontal direction and shifted by one sub-pixel from sorting the selective On-states in the odd and even fields in the horizontal direction, and is made in units of two lines in the vertical direction.

13. The image display method according to claim 4,
wherein sorting the selective On-states in the odd and even fields is made in units of two sub-pixels in the horizontal direction and in units of two lines in the vertical direction, and sorting the dither pattern is made in units of two sub-pixels in the horizontal direction and shifted by one sub-pixel from sorting the selective On-states in the odd and even fields in the horizontal direction, and is made in units of two lines in the vertical direction and shifted by one line similarly therefrom.

14. The image display method according to claim 4,
wherein sorting the selective On-states in the odd and even fields is made in units of two pixels in the horizontal direction and in units of two lines in the vertical direction, and sorting the dither pattern is made in units of two pixels in the horizontal direction and shifted by one sub-pixel from sorting the selective On-states in the odd and even fields in the horizontal direction, and is made in units of line in the vertical direction.

15. The image display method according to claim 14,
wherein sorting the selective On-states in the odd and even fields is made in units of two pixels in the horizontal direction and in units of line in the vertical direction, and sorting the dither pattern is made in units of two pixels in the horizontal direction and shifted by one pixel from sorting the selective On-states in the odd and even fields in the horizontal direction, and is made in units of two lines in the vertical direction.

16. The image display method according to claim 4,
wherein sorting the selective On-states in the odd and even fields is made in units of two pixels in the horizontal direction and in units of two lines in the vertical direction, and sorting the dither pattern is made in units of two pixels in the horizontal direction and shifted by one pixel from sorting the selective On-states in the odd and even fields in the horizontal direction, and is made in units of two lines in the vertical direction and shifted by one line similarly therefrom.

17. An image display apparatus comprising:
a display panel;
a driver for driving each of sub-pixels of the display panel; and
a control circuit for controlling the driver,
wherein the image display method according to claim 1 is applied to the image display apparatus.

18. The image display apparatus according to claim 17,
wherein the control circuit includes:
a sort timing generator circuit generating a dither sort timing signal and a timing signal for sorting odd and even fields while both signals are synchronized;
a dither pattern generator circuit receiving the dither sort timing signal and generating a predetermined dither pattern;
an adder circuit adding an input picture signal and the dither pattern from the dither pattern generator circuit; and
an On-state sub-field sort circuit receiving an output signal of the adder circuit and the timing signal for sorting the odd and even fields, and outputs a picture output signal in which sorting selective On-states in the odd and even fields and sorting a dither pattern are made to differ from each other in at least one of a horizontal direction and a vertical direction.
